(19) United States
(12) Patent Application Publication
(10) Pub. No.: US 2026/0164235 A1
(43) Pub. Date: Jun. 11, 2026

(54) DIRECT C2 COMMUNICATIONS SETUP, MODIFICATION, AND REVOCATION

(71) Applicant: InterDigital Patent Holdings, Inc., Wilmington, DE (US)

(72) Inventors: Samir Ferdi, Kirkland (CA); Aneeqa Ijaz, Tulsa, OK (US); Guanzhou Wang, Brossard (CA); Taimoor Abbas, Sainte-Julie (CA)

(73) Assignee: InterDigital Patent Holdings, Inc., Wilmington, DE (US)

(21) Appl. No.: 18/707,246

(22) PCT Filed: Nov. 4, 2022
(86) PCT No.: PCT/US2022/048970

§ 371 Date: May 3, 2024

Related U.S. Application Data
(60) Provisional application No. 63/276,264, filed on Nov. 5, 2021.

(51) Int. Cl. H04W 12/06; G08G 5/00; H04W 76/14; H04W 92/18

(52) U.S. Cl. CPC H04W 12/06; G08G 5/00; H04W 76/14; H04W 92/18

(57) ABSTRACT

Systems and methods are described herein for command and control (C2) communications setup, modification, and/or revocation. The C2 communications may be direct C2 communications. A C2 authorization may be performed by a wireless transmit and receive unit (WTRU) (e.g., an unmanned (uncrewed) aerial vehicle (UAV)). The C2 authorization may be performed by a WTRU, for example, if the WTRU sends a C2 communication request. The C2 communication request may be sent to an unmanned (uncrewed) aerial system (UAS) service supplier (USS), for example, via a UAS network function (NF) during a packet data unit (PDU) session establishment and/or modification. The WTRU may perform discovery of a peer WTRU, for example, after successful authorization.

### CROSS-REFERENCE TO RELATED APPLICATIONS

The application claims the benefit of U.S. Provisional Application 63/276,264, filed Nov. 5, 2021, the contents of which are incorporated by reference in their entirety herein.

### BACKGROUND

Mobile communications using wireless communication continue to evolve. A fifth generation may be referred to as 5G. A previous (legacy) generation of mobile communication may be, for example, fourth generation (4G) long-term evolution (LTE).

### SUMMARY

Systems and methods are described herein for command and control (C2) communications setup, modification, and/or revocation. The C2 communications may be direct C2 communications. A C2 authorization may be performed by a wireless transmit and receive unit (WTRU) (e.g., an unmanned (uncrewed) aerial vehicle (UAV). The C2 authorization may be performed by a WTRU, for example, if the WTRU sends a C2 communication request. The C2 communication request may be sent to an unmanned (uncrewed) aerial system (UAS) service supplier (USS), for example, via a UAS network function (NF) during a packet data unit (PDU) session establishment and/or modification. The WTRU may perform discovery of a peer WTRU, for example, after successful authorization.

For example, the WTRU may perform a C2 communication (e.g., a direct C2 communication) setup, modification, and/or revocation. The WTRU (e.g., UAV, UAV-C, and/or the like) may send an authorization request (e.g., a C2 over PC5 authorization request) during a PDU session establishment and/or modification. The authorization request may correspond with a C2 communication, such as direct or line-of-sight C2 communication. The WTRU may receive authorization (e.g., in an authorization response) for direct C2, for example, from a USS via a PDU session modification or a separate PDU establishment response message. The authorization may include authorization information. The WTRU may receive C2 authorization parameters (e.g., in an aviation container to facilitate discovery procedure with a UAV-C (e.g., UAS app user ID, discovery credentials, etc.), for example, to use as part of direct discovery (e.g., open or restricted direct discovery). The WTRU may perform (e.g., start) discovery. In examples, the WTRU may perform discovery on the condition that the WTRU receives C2 authorization information from the USS. The WTRU may use parameters from the USS to enable discovery with the UAV-C.

In an example, a network function (NF) may perform C2 communication (e.g., direct C2 communication) setup, modification, and/or revocation. The NF (e.g., UAS NF) may receive an authorization request from a session management function (SMF), for example, to enable PC5 over C2. The UAS NF may forward the authorization request to a USS. The UAS NF may receive the authorization response from the USS indicating that C2 over PC5 is authorized. The UAS NF may store the authorization information. The UAS NF may forward the authorization response to the SMF.

For example, a management function (e.g., direct discovery name management function (DDNMF)) may perform direct discovery procedures for a UAVIUAV-C. The DDNMF may receive a discovery request. The discovery request may include a UAS ProSe app ID (e.g., set to CAA level ID), a WTRU ID, and/or the like. The DDNMF may check with a unified data management (UDM) for the authorization of discovery for UAS ProSe app ID. The DDNMF may interact with the UAS NF, for example, based on associated subscription data (e.g., UAS app ID is associated with an USS/UAS application). The DDNMF may send a request message to UAS NF for discovery authorization. The DDNMF may receive a response message from the UAS NF. The response message may include authorization information for discovery, such as an authorization flag or a UAS discovery code. The DDNMF may send (e.g., to the UAV) a discovery response message. The discovery response message may include the UAS information for discovery.

In examples, a first WTRU may send a first message to a network node indicating a C2 authorization request and a request for a PDU session. The first WTRU may receive a second message from the network node indicating that the PDU session has been established. The second message may indicate a C2 authorization and C2 authorization information. The first WTRU may deter mine that the first WTRU is authorized to communicate with a second WTRU based on the C2 authorization and C2authorization information. The C2 authorization information may include a security credential (e.g., authorization token) and an identity of the second WTRU. The first WTRU may send a third message to the second WTRU using PC5, for example, if the first WTRU is authorized to communicate with the second WTRU. The third message may be protected based on the security credential (e.g., authenticated and/or encrypted using the security credential). The third message may indicate a request to perform a discovery procedure and/or a link establishment procedure.

In examples, a network node (e.g., UAS NF) may send a first message to a second network node indicating a request for authorization associated with a WTRU. The network node may receive a second message indicating a response to the request, indicating policy configuration information, and/or indicating a security credential associated with the WTRU. The network node may determine that the WTRU is authorized to establish C2 over PC5 (e.g., based on the second message). The network node may determine discovery authorization parameter(s), for example, based on the second message. The network node may send a third message to the WTRU indicating the discovery authorization parameter(s).

In examples, a network node (e.g., UAS NF) may receive a first message indicating an authorization request associated with discovery. The authorization request may indicate a subscription identifier associated with a first WTRU, a UAV identifier, a request type, an application level container, and/or the like. The request type may indicate whether the discovery is open or restricted. The network node may determine that a first WTRU is authorized to operate as a UAV and/or authorized to perform C2 communication. The network node may determine that the first WTRU is authorized, for example, based on a received indication (e.g., from a USS). The network node may send a second message indicating an authorization response (e.g., associated with the first message) indicating that the WTRU is authorized to operate as a UAV. The second message may indicate that the first WTRU is authorized to perform open discovery (e.g., if the request type is associated with open discovery). The second message may indicate that the first WTRU is authorized to perform restricted discovery (e.g., if the request type is associated with restricted discovery). The network node may determine parameter(s), for example, based on the request type (e.g., restricted discovery parameters for restricted discovery, open discovery parameters for open discovery).

The discovery request may be a discovery request for monitoring. The discovery request for monitoring may indicate a subscription identifier associated with a first WTRU, a UAV identifier, a Prose Discovery UE identifier (PDUID), a target subscription identifier associated with a second WTRU, a target UAV identifier, and/or a target PDUID. The network node may send a message indicating a monitoring response.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example overview of a C2 over PC5 direct communication.

FIG. 3 illustrates an example UAV and UAV-C communication network using one or more PLMNs.

FIG. 4 illustrates an example of PC5 direct communication with C2 authorization that may be followed by discovery.

FIG. 5 illustrates an example PC5 direct communication with UAS peer discovery that may be followed by C2 authorization.

FIG. 6 Illustrates an example C2 authorization involving PCF and USS via UAS NF.

FIG. 7 illustrates an example announce request procedure (roaming/inter-PLMN transmission) contacting USS via V/local PLMN.

FIG. 8 illustrates an example announce request procedure (roaming/inter-PLMN transmission) contacting USS via V/local PLMN.

FIG. 9 illustrates an example announce request procedure for restricted discovery (non-roaming).

FIG. 10 illustrates an example monitor request procedure for restricted discovery (non-roaming).

### DETAILED DESCRIPTION

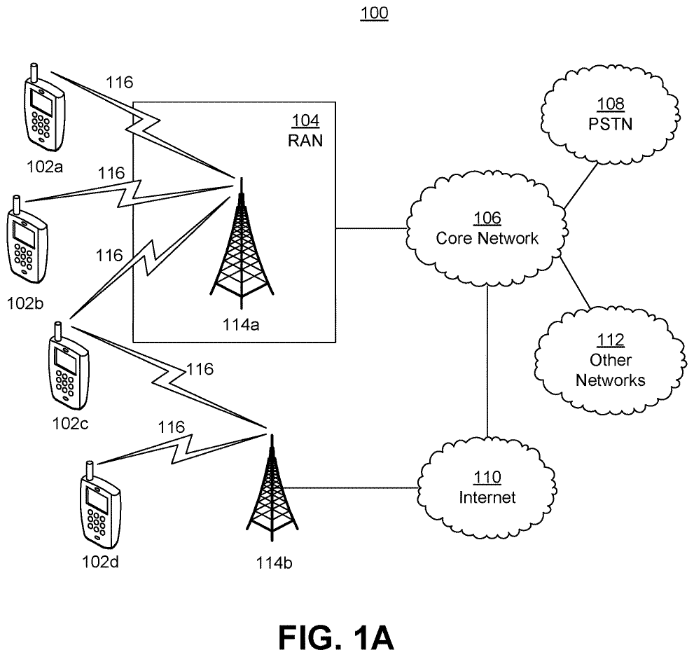

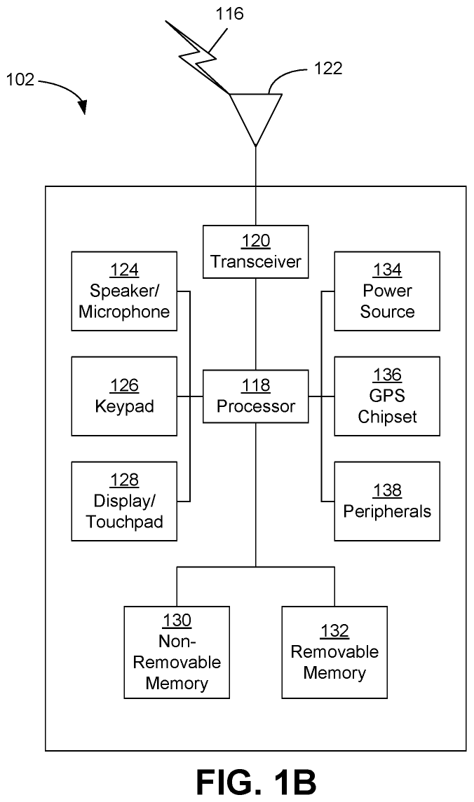

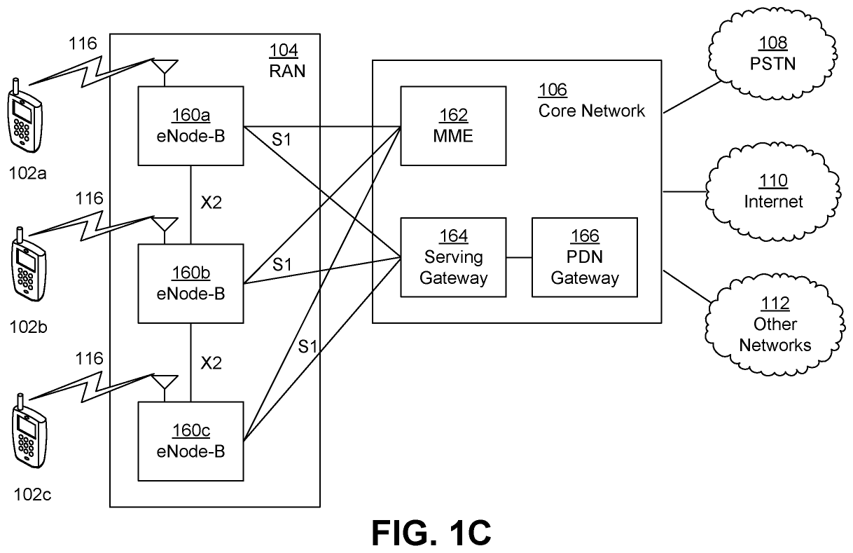

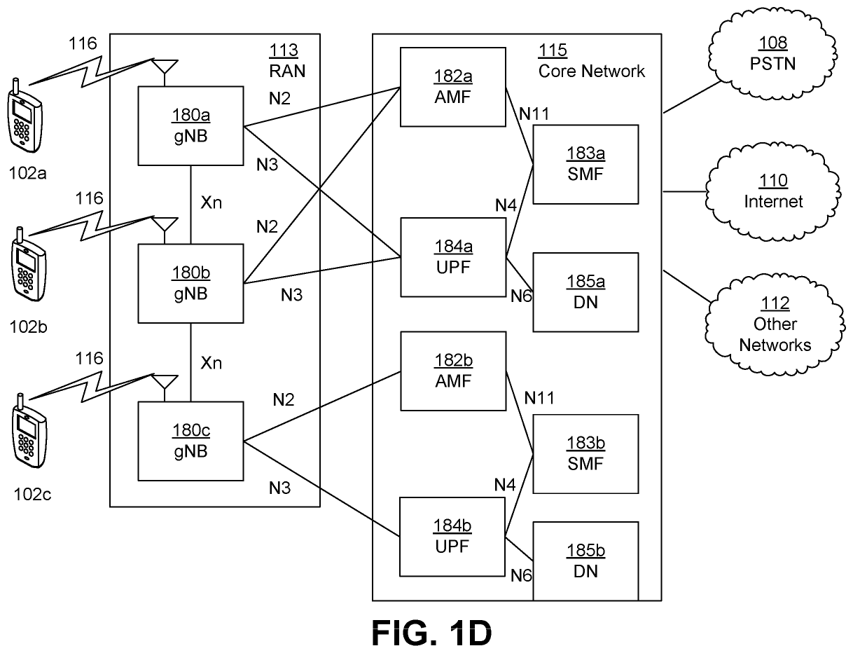

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE,

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114 a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114 a in the RAN 104/113 and the WTRUs 102 a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WIFI), IEEE 802.16 (i.e., Worldwide Interoperability for Microwave Access (WIMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102 d may Implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 1020, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114 b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WIFI radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NIMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102 a, 102 b, 102 c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like, As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an Interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS), In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11 ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology, For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102 a, 102 b, 102 c may implement DC principles to communicate with one or more gNBs 180 a, 180 b, 180 c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WIFI.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 Interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems and methods are described herein for command and control (C2) communications setup, modification, and/or revocation. The C2 communications may be direct C2 communications. A C2 authorization may be performed by a wireless transmit and receive unit (WTRU) (e.g., an unmanned (uncrewed) aerial vehicle (UAV). The C2 authorization may be performed by a WTRU, for example, if the WTRU sends a C2 communication request. The C2 communication request may be sent to an unmanned (uncrewed) aerial system (UAS) service supplier (USS), for example, via a UAS network function (NF) during a packet data unit (PDU) session establishment and/or modification. The WTRU may perform discovery of a peer WTRU, for example, after successful authorization.

For example, the WTRU may perform a C2 communication (e.g., a direct C2 communication) setup, modification, and/or revocation. The WTRU (e.g., UAV, UAV-C, and/or the like) may send an authorization request (e.g., C2 over PC5 authorization request) during a PDU session establishment and/or modification. The authorization request may correspond with a C2 communication, such as direct or line-of-sight C2 communication. The WTRU may receive authorization (e.g., in an authorization response) for direct C2, for example, from a USS via a PDU session modification or a separate PDU establishment response message. The authorization may include authorization information. The WTRU may receive C2authorization parameters (e.g., in an aviation container to facilitate discovery procedure with a UAV-C (e.g., UAS app user ID, discovery credentials, etc.), for example, to use as part of direct discovery (e.g., open or restricted direct discovery). The WTRU may perform (e.g., start) discovery. In examples, the WTRU may perform discovery on the condition that the WTRU receives C2 authorization information from the USS. The WTRU may use parameters from the USS to enable discovery with the UAV-C.

In an example, a network function (NF) may perform C2 communication (e.g., direct C2communication) setup, modification, and/or revocation. The NF (e.g., UAS NF) may receive an authorization request from a session management function (SMF), for example, to enable PC5 over C2.The UAS NF may forward the authorization request to an USS. The UAS NF may receive the authorization response from the USS indicating that C2 over PC5 is authorized. The UAS NF may store the authorization information. The UAS NF may forward the authorization response to the SMF.

For example, a management function (e.g., direct discovery name management function (DDNMF)) may perform direct discovery procedures for a UAV/UAV-C. The DDNMF may receive a discovery request. The discovery request may include a UAS ProSe app ID (e.g., set to CAA level ID), a WTRU ID, and/or the like. The DDNMF may check with unified data management (UDM) the authorization for discovery for UAS ProSe app ID based on associated subscription information. The DDNMF may determine to interact with the UAS NF, for example, based on associated subscription data (e.g., UAS app ID is associated with a USS/UAS application). The DDNMF may send a request message to UAS NF for discovery authorization. The DDNMF may receive a response message from the UAS NF. The response message may include authorization information for discovery, for example, such as an authorization flag or a UAS discovery code. The DDNMF may send (e.g., to the UAV) a discovery response message. The discovery response message may include the UAS information for discovery.

In examples, a first WTRU may send a first message to a network node indicating a C2 authorization request and a request for a PDU session. The first WTRU may receive a second message from the network node indicating that the PDU session has been established. The second message may indicate a C2 authorization and C2 authorization information. The first WTRU may determine that the first WTRU is authorized to communicate with a second WTRU based on the C2 authorization and C2 authorization information. The C2 authorization information may include a security credential (e.g., authorization token) and an identity of the second WTRU. The first WTRU may send a third message to the second WTRU using PC5, for example, if the first WTRU is authorized to communicate with the second WTRU. The third message may be protected based on the security credential (e.g., authenticated and/or encrypted using the security credential). The third message may indicate a request to perform a discovery procedure and/or a link establishment procedure.

In examples, a network node (e.g., UAS NF) may send a first message to a second network node indicating a request for authorization associated with a WTRU. The network node may receive a second message indicating a response to the request, indicating policy configuration information, and/or indicating a security credential associated with the WTRU. The network node may determine that the WTRU is authorized to establish C2 over PC5 (e.g., based on the second message). The network node may determine discovery authorization parameter(s), for example, based on the second message. The network node may send a third message to the WTRU indicating the discovery authorization parameter(s).

In examples, a network node (e.g., UAS NF) may receive a first message indicating an authorization request associated with discovery. The authorization request may indicate a subscription identifier associated with a first WTRU, a UAV identifier, a request type, an application level container, and/or the like. The request type may indicate whether discovery is open discovery or restricted discovery. The network node may determine that a first WTRU is authorized to operate as a UAV and/or authorized to perform C2 communication. The network node may determine that the first WTRU is authorized, for example, based on a received indication (e.g., from a USS). The network node may send a second message indicating an authorization response (e.g., associated with the first message) indicating that the WTRU is authorized to operate as a UAV. The second message may indicate that the first WTRU is authorized to perform open discovery (e.g., if the request type is associated with open discovery). The second message may indicate that the first WTRU is authorized to perform restricted discovery (e.g., if the request type is associated with restricted discovery). The network node may determine parameter(s), for example, based on the request type (e.g., restricted discovery parameters for restricted discovery, open discovery parameters for open discovery).

The discovery request may be a discovery request for monitoring. The discovery request for monitoring may indicate a subscription identifier associated with a first WTRU, a UAV identifier, a PDUID, a target subscription identifier associated with a second WTRU, a target UAV identifier, and/or a target PDUID. The network node may send a message indicating a monitoring response.

An unmanned (e.g., uncrewed) aerial system (UAS) may be supported. Additional enhancements may be provided for UAS support. An unmanned (e.g., uncrewed) aerial vehicle (UAV) may be controlled, for example, using command and control (C2) messages and/or communications from a UAV Controller (UAV-C) and/or a UAS service supplier (USS)/UAS traffic manager (UTM).

Types of C2 communications may include one or more of the following: direct; network-assisted; or UTM-navigated. A direct C2 may correspond with a UAV-C and/or UAV using a direct C2 communication link (e.g., D2D, PC5) to communicate. A network-assisted C2 communication may correspond with a UAV-C and UAV using unicast C2 communication links (e.g., over Uu) with the network to communicate. Flying the UAV beyond visible line of sight (BVLOS) may be enabled/supported, for example, using network-assisted C2 communications (e.g., unlike direct C2 communications). UTM-navigated C2 communications may correspond with a UAV with autonomous flying capabilities that may be able to fly according to a pre-scheduled flight plan under the supervision of a UTM. The C2 communication link between UAV and UTM may be used for flight monitoring, dynamic route updates, and/or occasional navigation.

ProSe (e.g., 5G ProSe) may support PC5 direct communication between WTRUs (e.g., two WTRUs) and may allow discovery, for example, by using a direct discovery name management function (DDNMF) and leveraging the ProSe Application server. ProSe (e.g., 5G ProSe) may support discovery and communication for WTRUs in general (e.g., WTRUs that are not UAVs).

Support may be provided (e.g., only) for indirect C2 communication, e.g., the USS may allow (e.g., via a UAS network function (NF)) C2 communication. The C2 communication may be performed using (e.g., through) a PDU session. The UAV may discover the UAV-C (e.g., which may be a non-networked device, for example, such as a ground station with Internet connection) for C2 communication, for example, by obtaining the UAV-C IP address from the USS with network assistance, e.g., during a pairing/C2 authorization procedure,

A web-based API interface between the core network and USS may be provided and/or used.

One or more mechanisms to support authorization for direct C2 communication (e.g., over PC5) may be enabled. For example, mechanisms to support authorization for direct C2 communication (e.g., over PC5) may be enabled if a UAV may (e.g., need to) fly in proximity of the UAV-C in line of sight (LOS). For example, mechanisms to support authorization for direct C2 communication (e.g., over PC5) may be enabled if the operator or the USS restricts (e.g., needs to restrict) the operations to LOS (e.g., LOS only).

Some communication technologies, such as 5G ProSe, may not support scenarios where the authorization for direct one-to-one communication may use (e.g., require) a third party (e.g., USS) authorization for the provisioning of C2 authorization in addition to MNO authorization. Mechanisms to support authorization for direct C2 communication by USS may be used (e.g., needed) to complement the existing mechanisms for network-assisted C2 communications authorization.

C2 communication authorization, such as Direct C2 communication authorization, may be enabled, for example, by leveraging the network exposure function (NEF)/UAS NF to accommodate a web-based API interface requirement from this vertical. For direct C2 communication, it may be desirable for the peers (e.g., UAV and UAV-C) to perform discovery and link establishment, for example, while leveraging existing 5G ProSe corresponding procedures.

UAV and UAV-C may discover each other, establish a communication link, modify a communication link, and/or release a communication link used for Direct (D2D, PC5) C2 communications. UAV and UAV-C may be authorized for LOS/D2D C2 (e.g., by leveraging USS UAV authorization/authentication (UUAA) and/or C2 authorization). UAV and UAV-C may discover and connect for LOS/D2D C2 communication. The USS/UTM may be used to establish, modify, and revoke a direct security association used for C2 communication. UAV and UAV-C may authenticate each other and establish a secure PC5 link for C2 communication.

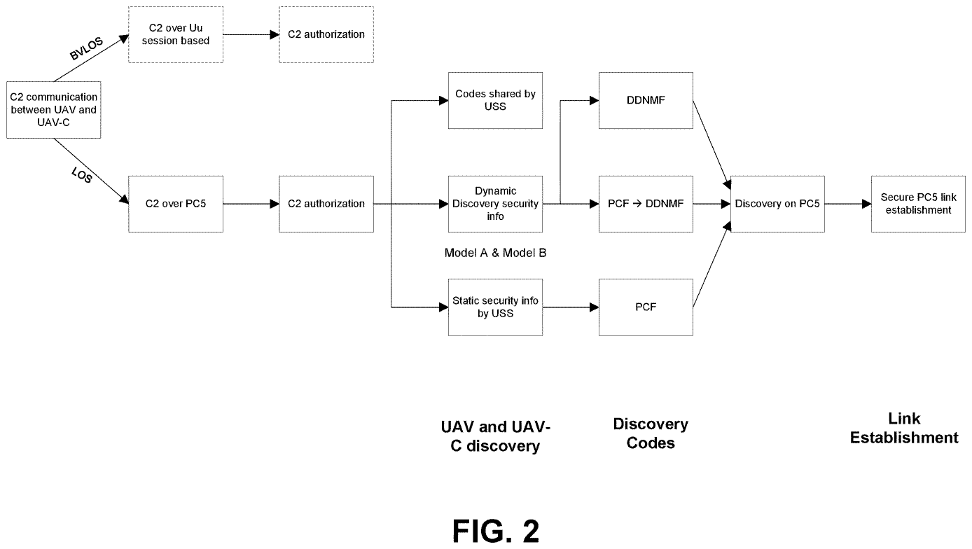

FIG. 2 illustrates an example overview of a C2 over PC5 direct communication. C2 over PC5 may be provided, for example, to add support for the authorization of LOS operations. Direct C2 authorization may be performed, for example, if a ProSe capable UAV (e.g., WTRU) sends a (e.g., direct) C2 communication request to the USS (e.g., via UAS NF during PDU session establishment/modification). The UAVIUAV-C may perform discovery of the peer UAV-C/UAV, for example, based on (e.g., after) successful authorization.

Discovery may be dynamic, for example, by leveraging DDNMF (e.g., using an open/restricted mode of discovery). Discovery may be static, for example, by involving policy control functions (PCF), SMF and/or USS. UAV(s) can receive the dynamic discovery code(s) (e.g., directly) from DDNMF. Discovery code(s) can be provisioned by PCF using a USS initiated policy configuration.

PC5 link establishment may be performed, for example, after the (e.g., secure) discovery of the UAS peer(s). This D2D link can be secured using the existing security mechanisms.

For example, a system may provide communication capabilities between the UAV and UAV-C, which may communicate through the same or different public land mobile networks (PLMNs). UAV and UAV-C may be equipped with a WTRU, for example, to enable device-to-device (D2D) communications (e.g., PC5). A WTRU may refer to a UAV or UAV-C herein. For example, the UAV and UAV-C roles can be interchanged in the procedures described herein. For example, the UAV may correspond with the role of discoverer/monitoring, and UAV-C may correspond with the role of discovereelannouncer, for example, during direct discovery procedure or vice-versa. The UAV or UAV-C may initiate the direct link establishment procedure. Both the UAV and the UAV-C may perform direct C2 authorization. The civil aviation administration-level identity (CAA level ID) and WTRU ID referred herein may correspond to a CAA level UAV ID and UAV ID (e.g., GPSI) for a UAV or the equivalent identifiers for a UAV-C.

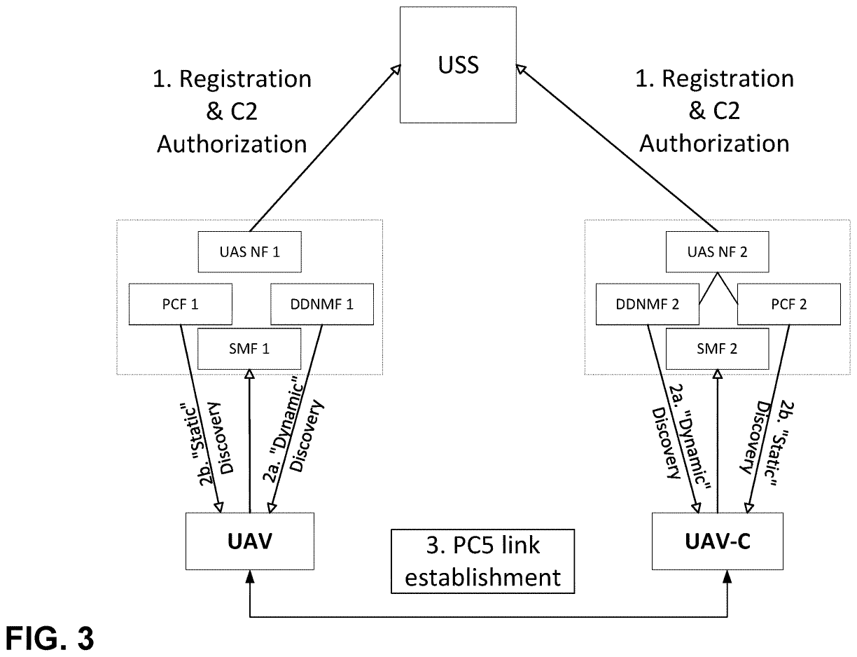

FIG. 3 illustrates an example UAV and UAV-C communication network using one or more PLMNs. As shown in FIG. 3, the UAV and UAV-C may be connected to different PLMNs and then to the same USS.

C2 communication authorization, such as direct C2 communication authorization, may be provided for UAVIUAV-C. C2 authorization may be enhanced to allow C2 over Uu and/or direct (e.g., PC5).

The WTRU (e.g., UAV and/or UAV-C) may indicate LOS and/or BVLOS or direct and/or network-assisted/indirect C2 communication, for example, if requesting C2 authorization (e.g., in a NAS message, in a UAS container) in a PDU Session establishment/modification request message. The WTRU may indicate its support for direct C2 communication (e.g., C2 over PC5) in the C2 authorization request.

The WTRU may obtain authorization information for direct C2 communication (e.g., parameters for peer discovery such as peer(s) CAA level ID/WTRU ID and/or credentials for direct link security, for example, in a NAS message/UAS container) in a message from an SMF (e.g., PDU Session establishment accept/command) and/or from a PCF (e.g., in a WTRU configuration update (UCU)). The type of C2 communication authorized (e.g., direct or indirect) may be provided to the UAV (e.g., by the network), for example, in a UAS application container.

The network function (e.g., SMF) that initiates the C2 authorization procedure with the USS may determine whether the WTRU supports direct C2 communication, for example, based on WTRU capability information. whether the WTRU supports/is authorized for communication, such as ProSe communication. The network function may include the C2 support, such as direct C2 support, indication in the authorization request to the USS.

The UAS NF/NEF may receive C2 authorization information from USS for LOS/direct and/or BVLOS/indirect communications. The C2 authorization information may include peer(s) CAA Level ID/WTRU ID and/or security credentials for establishing secure direct/indirect links for C2 communication. The UAS NF may map aviation domain (e.g., LOS/BVLOS) authorization information parameters respectively to C2 over a direct link (e.g., PC5) or indirect link (e.g., over Uu). The UAS NF may transmit the authorization information to the SMF/PCF.

In examples, the USS may refrain from providing (e.g., not provide) policy configuration information corresponding with a PDU Session established for C2 communication (e.g., refrains from providing (e.g., does not provide) an authorized peer UAV-C IP address via UAS NF) while providing authorization (e.g., via UAS NF) for direct C2 communication, for example, if the UAV is restricted to LOS operations. The USS may allow both modes of communication whereby the UAV and UAV-C may switch C2 communication between the direct/LOS and indirect/BVLOS communication modes, for example, using C2 switching mechanisms.

Peer discovery, such as a direct discovery of a peer of the UAVIUAV-C, may be enabled. DDNMF/PCF may be enhanced to support dynamic/static discovery between a UAV and a UAV-C. DDNMF may use an interface with UAS NF for USS assisted authorization of UAV-UAV-C direct discovery (e.g., to obtain code seed, UAS peer(s) identifier(s), discovery key material).

A DDNMF may receive a discovery request including a UAS ProSe app ID (e.g., set to CAA level ID), WTRU ID, and/or a ProSe app ID corresponding to a UAS app ID. The DDNMF may check with unified data management (UDM) that the authorization for discovery for ProSe App ID/UAS ProSe App ID may be determined to interact with UAS NF, for example, based on the associated subscription data (e.g., UAS app ID is associated with a USS/UAS application). The DDNMF may send a request message to a UAS NF for discovery authorization. The DDNMF may receive a response message from a UAS NF. The response message may include authorization information for discovery (e.g., authorization flag, UAS discovery code, UAS peer identifiers). The DDNMF may send (e.g., to the UAV) a discovery response message. The discovery response message may include UAS information for discovery.

In examples, the USS may configure PCF with discovery authorization information (e.g., USS assigned discovery code/code suffix, discovery credentials), for example, via UAS NF as part of a policy control procedure initiated during a C2 authorization procedure (e.g., as described herein).

The WTRU may use the discovery code obtained from DDNMF or SMF/PCF, for example, to perform direct discovery of the UAS peer (e.g., over PC5). In examples, direct discovery and direct communication may be performed with direct WLAN communication. The discovery code may be associated with or correspond to an SSID.

Direct C2 communication may be established between UAV and UAV-C. The UAV and UAV-C IP may establish secure PC5 communication with USS assistance. UAV may use credentials for direct C2 communication received as part of direct C2 authorization (e.g., as described herein). Authorization information may include P5 link security key material (e.g., a shared key between UAV and UAV-C).

Direct C2 authorization and discovery models may be provided. A first model (e.g., model #1) may correspond with direct C2 authorization for direct discovery. In the first model (e.g., model #1), the UAV/UAV-C may be authorized for C2 communication with a peer UAV-C/UAV (e.g., whereby the peer identifier may be pre-configured in the UAV or USS), for example, after successful authentication and authorization by the USS. The UAVIUAV-C may perform direct discovery and direct link establishment for C2 communications, for example, after successful C2 authorization. The first model may be used, for example, if the pairing of UAV and UAV-C is pre-determined/pre-configured (e.g., by the pilot, USS).

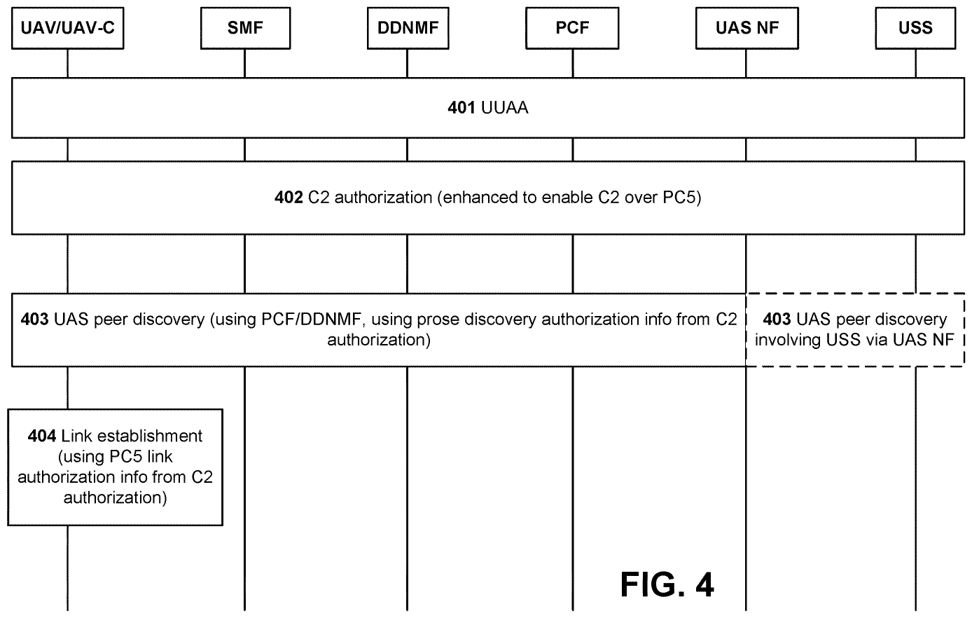

FIG. 4 illustrates an example of PC5 direct communication with C2 authorization followed by discovery. As shown in FIG, 4, UUAA (e.g., conventional UUAA) may be performed, for example, by the UAV/UAV-C (e.g., WTRU). The WTRU may be ProSe capable. The WTRU may provide related capabilities when registering with the network. As shown in FIG. 4, the WTRU may perform C2 authorization for LOS/direct and/or BVLOS/Indirect C2 communication (e.g., as described herein), for example, based on a pre-configured UAS peer in the WTRU or at the USS. As shown in FIG. 4, the WTRU can perform dynamic direct discovery (e.g., using dynamic discovery codes/filters from DDNMF or static codes obtained via PCF or SMF), for example, once the WTRU is authorized for C2 communication. The DDNMF may contact the UAS NF to retrieve discovery authorization information (e.g., authorization indication/flag, UAS peer identifier(s), remote identifier) providing a WTRU ID and/or WTRU's ProSe app user ID, for example, if the WTRU performs a direct discovery procedure ProSe. The UAS NF may retrieve the corresponding authorization information from USS during C2 authorization, for example, using the provided identifiers. The UAS NF may contact USS for authorization (e.g., additional authorization) for discovery (e.g., if UAS peer(s) identifier(s) at the UAS NF). As shown in FIG. 4, the secure direct link establishment between the peers may be performed (e.g., using credentials received during the C2 authorization procedure).

Direct discovery for direct C2 authorization may be provided. A second model (e.g., model #2) may correspond with direct discovery for direct C2 authorization. In the second model (e.g., model #2), the UAVIUAV-C (e.g., WTRU) may perform direct discovery to obtain the peer identifier to perform C2 communication, for example, after successful authentication and authorization by the USS. The WTRU may perform C2 authorization, for example, using the discovered peer identifier. The WTRU may perform direct link establishment for C2 communications, for example, after successful C2 authorization. The second model may be used, for example, if the pairing of UAV and UAV-C is not pre-determined (e.g., ad-hoc pairing, self-service model),

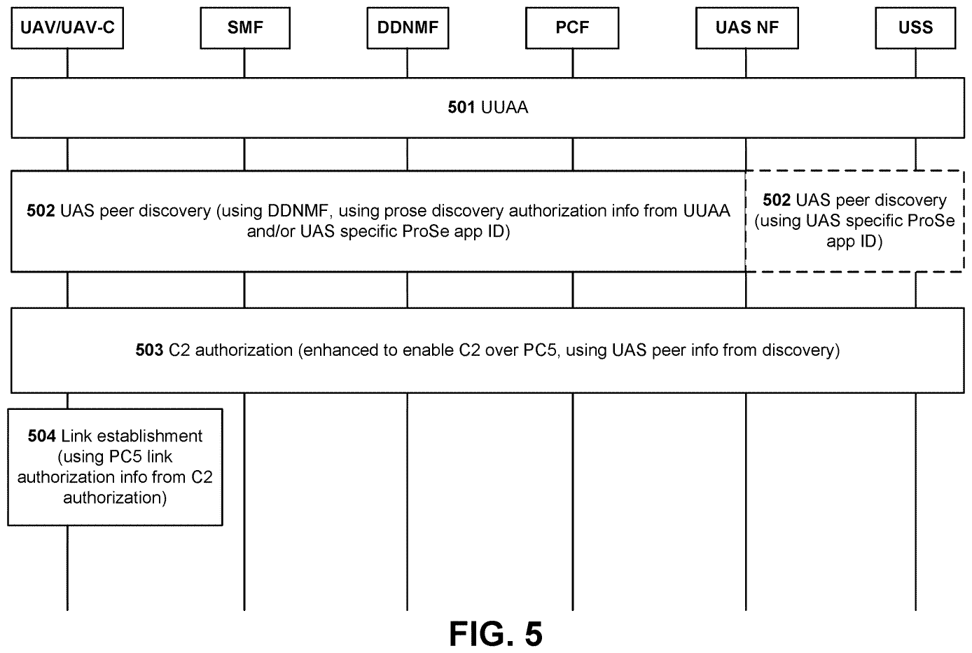

In examples, a discovery type (e.g., open/restricted) may be communicated/established at the UAS application layer (e.g., as part of a UAS app container), for example, in the end-to-end interaction between the USS and the UAVIUAV-C (e.g., as described herein with respect to FIGS. 5-10). For example, the parameter(s) (e.g., discovery type/request type) in the discovery messages may be optional (e.g., in the case of UAV). Whether the WTRU is monitoring/announcing may be established, for example, based on the role assigned to the UAV and the UAV-C by the application/USS (e.g., the UAV-C may be monitoring, and the UAV may be announcing or vice versa based on application preference). The type of discovery request can be preconfigured in the application (e.g., the type of discovery request may be indicated by received configuration information). The parameter may provide the information about the type of request to the UAS NF, and (e.g., in response) the UAS NF may send the (e.g., required) information to the DDNMF (e.g., for a monitoring restricted request. The UAS NF may provide the target UAS peer identifiers), for example, if the USS is not directly involved and the DDNMF is communicating with UAS NF.

FIG. 5 illustrates an example PC5 direct communication with UAS peer discovery followed by C2 authorization. As shown in FIG. 5 (e.g., at 501 in FIG. 5), UUAA (e.g., conventional UUAA) may be performed by the UAVIUAV-C (e.g., WTRU), for example, as described herein with respect to FIG. 4. As shown in FIG. 5 (e.g., at 502 in FIG. 5), the dynamic discovery of the UAS peer may be performed first for (e.g., adhoc) pairing, for example, instead of performing the C2 authorization procedure (e.g., as described in FIG. 4 with respect to model #1). In examples, the WTRU (e.g., UAV) may be pre-configured with (e.g., receive configuration information indicating) the peer information (e.g., the identifier of the peer). The WTRU may (e.g., attempt to) match the peer information during the discovery procedure (e.g., as ProSe user info). In examples, the WTRU may be pre-configured (e.g., by a PCF) with a ProSe service code corresponding to a UAS service code (USC) used for UAS peer discovery. The WTRU may obtain the peer WTRU information (e.g., set to a CAA Level ID) during the discovery using the USC. As shown in FIG. 5 (e.g., at 503 in FIG. 5), the WTRU may send discovered peer information (e.g., such as the identifier (e.g., CAA-Level UAV ID or generic public subscription identifier (GPSI)) of the peer) in the C2 authorization request (e.g., instead of using a pre-configured peer identifier), for example, once the WTRU discovers its peer using codes provisioned by DDNMF/PCF. As shown in FIG. 5 (e.g., at 504 in FIG. 5), the secure direct link establishment between the peers is performed as described above, for example, based on successful C2 authorization.

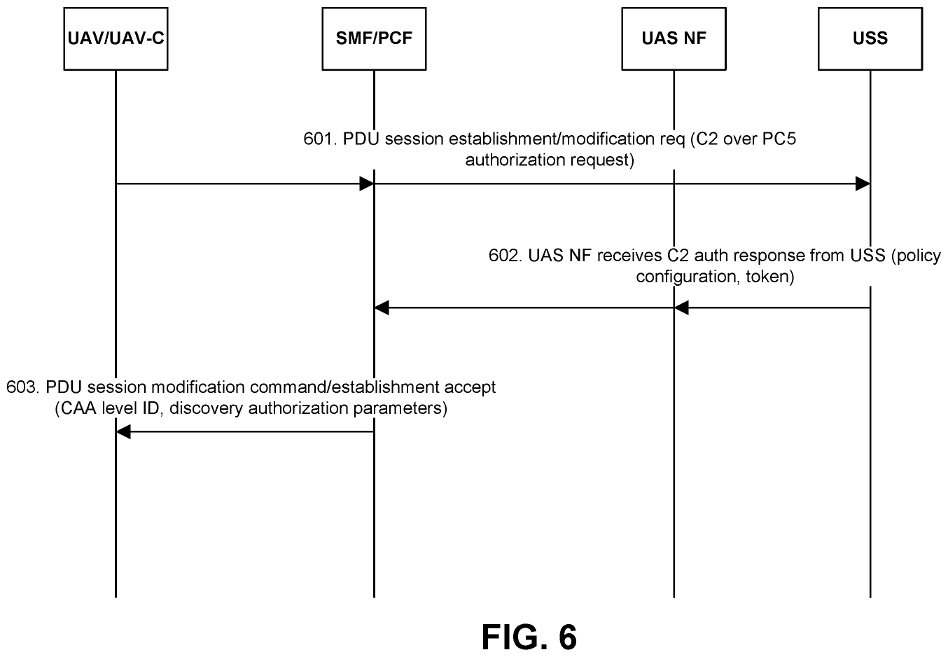

C2 authorization, such as direct C2 authorization (e.g., non-roaming), may be performed. FIG. 6 illustrates an example C2 authorization involving PCF and USS via UAS NF. As shown in FIG. 6 (e.g., at 601 in FIG. 6), the WTRU (e.g., ProSe capable WTRU) may send a PDU session establishment/modification request for direct C2 communication (e.g., with a second WTRU) to the SMF. The message may contain a C2 over the PC5 authorization request (e.g., a first message, where the first message indicates a C2 authorization request and a request for a PDU session). The SMF may forward the request for the authorization of C2 connection to USS (e.g., via the UAS NF),

As shown in FIG. 6 (e.g., at 602 in FIG. 6), the UAS NF may receive a C2 authorization response from the USS. The USS may forward the C2 authorization response to the SMF (e.g., send a first message indicating a request for authorization associated with a WTRU). The USS may provision the C2 authorization information (e.g., indication/code and security information) for the PCF and may provide the C2 authorization information to the PCF. The USS may provide the home PLMN (HPLMN) UAS NF an authorization token that the UAS NF can use to request discovery authorization from an USS, for example, while the WTRU is roaming (e.g., as described herein). The UAS NF may receive a second message from the USS (e.g., indicating a response to the request, indicating policy configuration information and a security credential associated with the WTRU). The UAS NF may request a PDUID from the PCF, for example, based on a successful authorization from the USS (e.g., the UAS NF may determine that the WTRU is authorized to establish C2 over PC5, e.g., based on the successful authorization from the USS (e.g., the indicated response to the request and the indicated policy configuration information).

As shown in FIG. 6 (e.g., at 603 in FIG. 6), authorization to initiate discovery may be provided to the WTRU by a subsequent PDU Session modification command (e.g., indicating the discovery authorization parameter). Direct C2 authorization may be provided by the PCF In a UCU. The WTRU may determine that the WTRU is authorized to communicate with a second WTRU (e.g., based on C2 authorization and C2 authorization information, where the C2 authorization information includes a security credential and an identity of a second WTRU). The WTRU may send a message to the second WTRU using PC5 (e.g., based on the C2 authorization), for example, using the security credential (e.g., authorization token). The message may indicate a request to perform a discovery procedure and/or link establishment procedure. The message may be protected (e.g., authenticated and/or encrypted), for example, using the security credential

The UAV/UAV-C may broadcast the CAA level ID it receives during the C2 authorization, for example, to discover the UAV-C/UAV and link establishment.

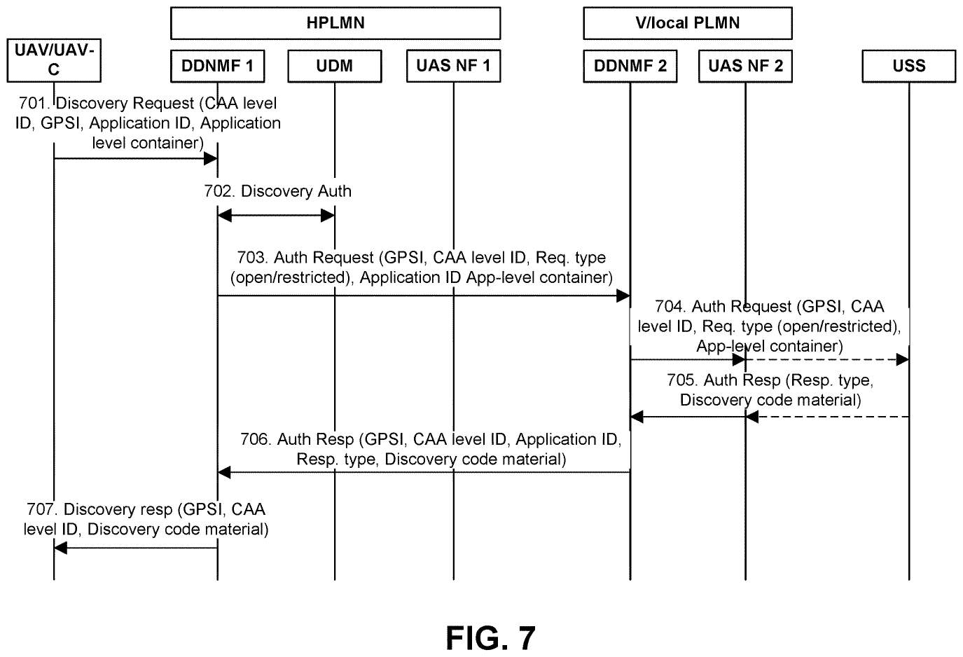

ProSe discovery may be performed. For example, ProSe discovery may correspond with open discovery (e.g., roaming). FIG. 7 illustrates an example announce request procedure (roaming/inter-PLMN transmission) contacting USS via V/local PLMN. As shown in FIG. 7, the WTRU may be authorized to announce (e.g., in the HPLMN). The WTRU may be triggered to announce (e.g., by the application layer). The WTRU may send a discovery request (e.g., CAA level ID, App ID, UAS container) message to the DDNMF 1 (e.g., as shown at 701 in FIG. 7).

As shown in FIG. 7 (e.g., at 702 in FIG. 7), the DDNMF 1 may check for the authorization of the application represented by the application ID. The UDM may provide the PLMN ID (e.g., visiting PLMN (VPLMN) of where the WTRU is registered. The DDNMF may determine that a UAS NF needs to be contacted, for example, based on subscription data associated with the app ID (e.g., corresponding to UAS app ID).

As shown in FIG. 7 (e.g., at 703 in FIG. 7), the DDNMF 1 may send the authorization request (e.g., GPSI (e.g., subscription identifier associated with a WTRU), CAA level ID (e.g., a UAV identifier), request type, Application ID, UAS container) to a DDNMF 2 in the VPLMN (e.g., where USS authorized the WTRU/UAV via VPLMN's UAS NF 2 (e.g., in a UUAA procedure). The DDNMF 1 may indicate that discovery authorization may be obtained via a UAS NF (e.g., indicates an authorization request associated with discovery).

As shown in FIG. 7 (e.g., at 704 in FIG. 7), the DDNMF 2 may forward the authorization request (e.g., received from the DDNMF 1 as described herein) to the UAS NF 2. The UAS NF 2 may forward the request to the USS, for example, if direct C2 authorization information for discovery is unavailable (e.g., discovery is performed before C2 authorization or the USS (e.g., requires) explicitly authorizes direct discovery) at the UAS NF 2. The UAS NF2 may determine that the WTRU is authorized to operate as a UAV and/or perform C2 communication (e.g., based on an indication received from the USS).

As shown in FIG. 7 (e.g., at 705 in FIG. 7), the UAS NF 2 may send an authorization response (e.g., response type, authorization indication to announce, discovery code material) message to DDNMF 2 (e.g., send a second message indicating that the first WTRU is authorized to operate as a UAV). The UAS NF2 may generate the response from locally stored information (e.g., from prior C2 authorization information) and/or after requesting the USS.

As shown in FIG. 7 (e.g., at 706 in FIG. 7), the DDNMF 2 may forward the message from the UASNF2/USS to the requesting DDNMF 1 in the HPLMN.

As shown in FIG. 7 (e.g., at 707 in FIG. 7), the DDNMF 1 in HPLMN may respond to the WTRU with a discovery response (e.g., GPSI, CAA level ID, discovery code material).

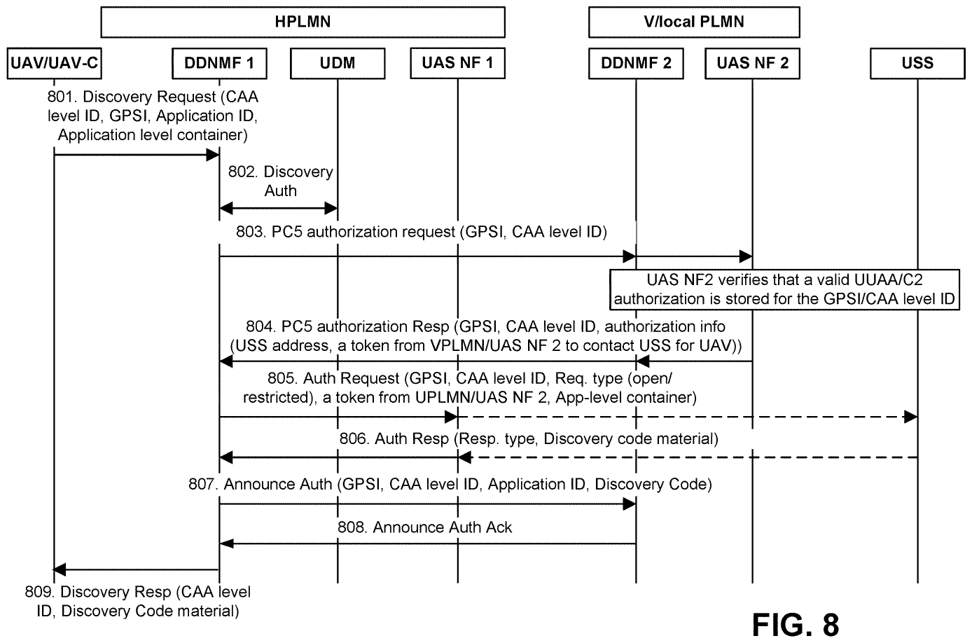

For example, ProSe discovery may correspond with open discovery (e.g., roaming). FIG. 8 illustrates an example monitor request procedure for discovery (non-roaming) contacting USS by getting the USS address from a local PLMN. As shown in FIG. 8, the WTRU may be authorized to announce in the HPLMN. The WTRU may be triggered to announce. The WTRU may send a discovery request (e.g., CAA level ID, GPSI, App ID, UAS container) message to the DDNMF 1 (e.g., at 801 in FIG. 8).

As shown in FIG. 8 (e.g., at 802 in FIG. 8), the DDNMF 1 may check for the authorization of the application represented by the application ID. The UDM may provide the VPLMN ID of where the WTRU is registered. The DDNMF may determine that a UAS NF may be (e.g., needs to be) contacted, for example, based on subscription data associated with the app ID (e.g., UAS app id).

As shown in FIG. 8 (e.g., at 803 in FIG. 8), the DDNMF 1 may send a PC5 authorization request to the DDNMF 2 (e.g., in the VPLMN where USS authorized the WTRU/UAV via VPLMN's UAS NF 2), The authorization request may include GPSI and/or the CAA level ID. The DDNMF 1 may indicate that discovery authorization information is to be obtained (e.g., via a UAS NF). The DDNMF 1 may Indicate that HPLMN may contact the USS directly. The UAS NF 2 may verify that a valid UUAA/C2 authorization is stored for this GPSI mapping to the WTRU. The UAS NF 2 may verify that an authorization token is available (e.g., to allow the HPLMN to contact the USS, for example, via the UAS NF 1).

As shown in FIG. 8 (e.g., at 804 in FIG. 8), the UAS NF 2 may send (e.g., based on the stored information) the PC5 authorization response to the DDNMF 1 (e.g., GPSI, CAA level ID, authorization information (e.g., USS address, an authorization token from to allow HPLMN to contact USS directly)) As shown in FIG. 8 (e.g., at 805 in FIG. 8), the DDNMF 1 may send the authorization request to the UAS NF 1 (e.g., CAA level ID, req. type (open/restricted), the authorization token from VPLMN/UAS NF 2, app-level container). The UAS NF1 may forward the request to the USS, for example, if no valid authorization information is locally available.

As shown in FIG. 8 (e.g., at 806 in FIG. 8), the UAS NF 1 may return the authorization response (e.g., response type, discovery code material) message to the DDNMF 2 of the HPLMN. The UAS NF1 may generate the response from locally stored information (e.g., from a prior discovery/C2 authorization procedure) and/or after requesting the USS.

As shown in FIG. 8 (e.g., at 807 in FIG. 8), the DDMF 1 may inform the DDNM 2 and may send an announce authorization (e.g., GPSI, CAA level ID, application ID, discovery code material) message, for example, if the WTRU is authorized to use that ProSe application ID.

As shown in FIG. 8 (e.g., at 808 in FIG. 8), the DDNMF 2 may send an announce authorization ACK to DDNMF 1, for example, to authorize the WTRU to perform direct discovery monitoring.

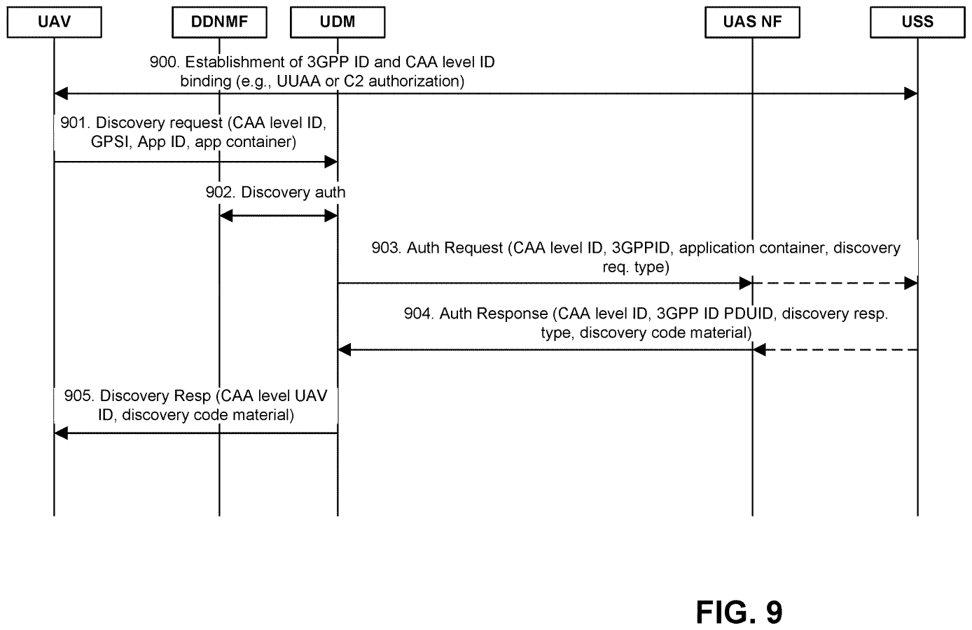

As shown in FIG. 8 (e.g., at 809 in FIG. 9), the DDNMF 1 may send a discovery response to the WTRU (e.g., CAA level UAV ID, discovery code material/filter). The DDNMF in the HPLMN may send the request to the DDNMF in the local/VPLMN and may receive a response filter for monitoring between the two DDNMF, for example, if/when addressing monitoring compared to announcing in open discovery.

A discovery announce request may be sent, for example, corresponding with restricted discovery Model A/Model B. FIG. 9 Illustrates an example announce request procedure for restricted discovery (non-roaming). As shown in FIG. 9 (e.g., at 900 in FIG. 9), the USS may allocate a CAA level ID (e.g., modified and/or new CAA level ID) for the WTRU (e.g., UAV/UAV-C), for example, during a prior UUAA or C2 authorization procedure and obtained from the network a WTRU ID in return. The WTRU, network (e.g., UAS NF), and/or USS may store a binding/mapping (e.g., corresponding with the CAA level ID) and the WTRU ID.

As shown in FIG. 9, the WTRU may (e.g., be authorized to) announce in the HPLMN. The WTRU may be triggered to announce. The WTRU may send a discovery request message (e.g., CAA level ID, GPSI, Application ID, UAS container) to the DDNMF (e.g., at 901 in FIG. 9).

As shown in FIG. 9 (e.g., at 902 in FIG. 9), the DDNMF may check for the discovery authorization of the application (e.g., represented by the application ID from the UDM). The DDNMF may determine that a UAS NF may be (e.g., needs to be) contacted, for example, based on subscription data associated with the app ID (e.g., UAS App ID), As shown in FIG. 9 (e.g., at 903 in FIG. 9), the DDNMF may send the authorization request (e.g., CAA level ID, application container, and discovery request type (e.g., open/restricted) to the UAS NF.

As shown in FIG. 9 (e.g., at 904 in FIG. 9), the UAS NF may return the authorization response (e.g., CAA level ID, WTRU ID, PDUID, response type, discovery code material) to the DDNMF. The WTRU ID(s) may be associated with the CAA level ID(s) stored in UAS NF. The UAS NF may generate the response, for example, from locally stored information (e.g., from a prior discovery/C2 authorization procedure) and/or after requesting the USS.

As shown in FIG. 9 (e.g., at 905 in FIG. 9), the DDNMF in the HPLMN may respond to the WTRU with a discovery response (e.g., CAA level ID, discovery code material).

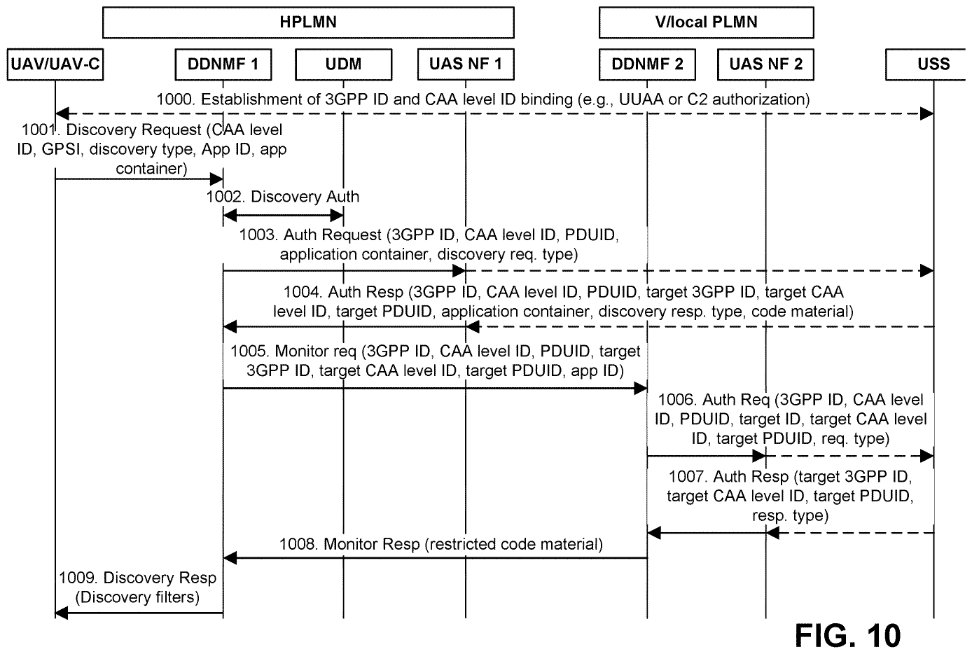

For example, a discovery monitor request may be sent in accordance with restricted discovery model, such as Model A or Model B. FIG. 10 illustrates an example monitor request procedure for restricted discovery (non-roaming). As shown in FIG. 10 (e.g., at 1000 in FIG. 10), the USS may allocate a CAA level ID (e.g., modified and/or new CAA level ID) for a WTRU (e.g., UAV/UAV-C), for example, during a prior UUAA or C2 authorization procedure, In return, the WTRU may obtain (e.g., from the network) a WTRU ID. The WTRU, network (e.g., UAS NF), and USS may store a binding/mapping between the CAA level ID and the WTRU ID. The WTRU may obtain the CAA level ID of those users (e.g., Target CAA level ID(s) from the USS via the network (e.g., during a C2 authorization procedure), for example, if the WTRU intends to communicate/discover a UAS peer. The WTRU may trigger monitoring, for example, by providing its own CAA level ID and the Target CAA level IDs to be monitored (e.g., which may be passed in an application-level container).

As shown in FIG. 10 (e.g., at 1001 in FIG. 10), the WTRU may send the discovery request message (e.g., CAA level ID, GPSI, discovery type, app ID, application-level container) to the DDNMF 1.

The application-level container may contain the target CAA level IDs of the UAS peers that the WTRU may monitor. The CAA level ID may indicate the identity the WTRU uses to obtain the authorization to monitor.

As shown in FIG. 10 (e.g., at 1002 in FIG. 10), the DDNMF 1 may check for the discovery authorization of the application represented by the application ID from the UDM. The DDNMF 1 may determine that a UAS NF 1 may be (e.g., needs to be) contacted, for example, based on subscription data associated with the app ID (e.g., UAS app ID).

As shown in FIG. 10 (e.g., at 1003 in FIG. 10), the DDNMF 1 may send the authorization request (e.g., ID, WTRU ID, CAA level ID, PDUID, application container, discovery request type (e.g., open/restricted)) to the UAS NF.

As shown in FIG. 10 (e.g., at 1004 in FIG. 10), the UAS NF 1 may send an authorization response message (e.g., WTRU ID, CAA level ID, PDUID, target WTRU ID, target CAA level ID, target PDUID, application container, discovery response type, discovery code material) to DDNMF1. The (e.g., each) target WTRUID out of the set of WTRUIDs may be returned with the corresponding target CAA UAV ID(s) that the CAA UAV ID may (e.g., be allowed) to discover. The DDNMF 1 may verify that the returned WTRU ID/PDUID belongs to the requesting WTRU. The application-level container may include the successfully authenticated target CAA UAV ID(s). The UAS NF1 may generate the response from locally stored information (e.g., from a prior discovery/C2 authorization procedure) and/or after requesting the USS.

As shown in FIG. 10 (e.g., at 1005 in FIG. 10), the DDNMF 1 in the HPLMN may send a monitoring request message (e.g., WTRU ID, CAA level ID, PDUID, target WTRU ID, target CAA level ID, target PDUID, app ID) to the DDNMF 2 in the other PLMN (e.g., to retrieve the corresponding restricted code), for example, if the PLMN ID in the target WTRUID indicates a PLMN different from the HPLMN.

As shown in FIG. 10 (e.g., at 1006 in FIG. 10), the DDNMF 2 in the other PLMN may send an authorization request (e.g., WTRU ID, PDUID, CAA level ID, target WTRU ID, target PDUID, target CAA level ID, request type) to the UAS NF2. The request type may be set to restricted discovery/permission.

As shown in FIG. 10 (e.g., at 1007 in FIG. 10), the UAS NF may send an authorization message (e.g., target WTRU ID, target CAA level ID, target PDUID, response type), for example, If the CAA level ID is allowed to discover the Target CAA level ID (e.g., based on the permission setting). The UAS NF2 may generate the response from locally stored information and/or after requesting the USS. The UAS NF may store and associate the identifiers of the monitoring WTRU and the target/announcing WTRU(s), for example, during a prior discovery or C2 authorization procedure. The UAS NF may verify the authorization to monitor by matching the DDNMF 2 provided identifiers (e.g., monitoring and target WTRU) with the identifiers stored. The DDNMF 2 may verify that the returned target WTRUID/PDUID corresponds to the WTRU to be monitored.

As shown in FIG. 10 (e.g., at 1008 in FIG. 10), the DDNMF 2 may send a monitor response (e.g., restricted code material) message to DDNMF 1. The DDNMF 2 may store (e.g., in the context of the announcing WTRU) the WTRUID of the monitoring WTRU.

As shown in FIG. 10 (e.g., at 1009 in FIG. 10), the DDNMF 1 may send a discovery response (e.g., discovery filters) message to the WTRU (e.g., for each pair of target WTRU ID—target CAA level ID returned by the UAS NF/USS), for example, if the DDNMF 1 has retrieved a (e.g., valid) ProSe restricted code.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-19. (canceled)

20. A first wireless transmit/receive unit (WTRU), the first WTRU comprising:
a processor configured to:
send a first message to a network node, wherein the first message indicates a command and control (C2) authorization request, indicates a request for a packet data unit (PDU) session, and indicates a request to use direct C2 communication;
receive a second message from the network node, wherein the second message indicates that the PDU session request is accepted, indicates a C2 authorization, and indicates C2 authorization information;
determine that the first WTRU is authorized to communicate with a second WTRU based on the C2 authorization and the C2 authorization information, wherein the C2 authorization information comprises an identity of the second WTRU; and
send a third message to the second WTRU using PC5 if the first WTRU is authorized to communicate with the second WTRU, wherein the third message indicates a request to perform or a link establishment procedure.

21. The first WTRU of claim 20, wherein the C2 authorization information comprises a security credential, and wherein the third message is encrypted based on the security credential.

22. The first WTRU of claim 20, wherein the C2 authorization information comprises a security credential, and wherein the security credential is an authorization token.

23. The first WTRU of claim 20, wherein the C2 authorization information comprises a security credential wherein the processor is further configured to:
determine, based on the security credential, a security key or a security token, and wherein the third message is based on the determined security key or determined security token.

24. The first WTRU of claim 20, wherein the C2 authorization information further comprises an unmanned aerial vehicle controller (UAV-C) application identifier.

25. A first network node, the network node comprising:
a processor configured to:
send a first message to a second network node, wherein the first message indicates a request for authorization, wherein the authorization is associated with a wireless transmit/receive unit (WTRU), and wherein the authorization is associated with direct command and control (C2) communication;
receive a second message from the second network node;
determine that the WTRU is authorized to establish C2 over PC5 based on the second message;
determine a discovery authorization parameter based on the second message; and
send a third message to the WTRU, wherein the third message indicates the discovery authorization parameter.

26. The first network node of claim 25, wherein the second message indicates a response to the request and indicates policy configuration information.

27. The first network node of claim 26, wherein the determination that the WTRU is authorized to establish C2 over PC5 based on the second message is performed based on the indicated response to the request and the indicated policy configuration information.

28. The first network node of claim 26, wherein the second message indicates a security credential associated with the WTRU, and wherein the discovery authorization parameter is determined using the second message based on the indicated policy configuration information and the indicated security credential.

29. The first network node of claim 28, wherein the security credential associated with the WTRU is an authorization token.

30. The first network node of claim 25, wherein the request for authorization is a request for permission to establish command and control (C2) over PC5.

31. The first network node of claim 25, wherein the third message further indicates an unmanned aerial vehicle controller (UAV-C) application identifier.

32. A method, the method comprising:
sending a first message to a network node, wherein the first message indicates a command and control (C2) authorization request, indicates a request for a packet data unit (PDU) session, and indicates to use direct C2 communication;
receiving a second message from the network node, wherein the second message indicates that the PDU session request is accepted, indicates a C2 authorization, and indicates C2 authorization information;
determining that a first wireless transmit/receive unit (WTRU) is authorized to communicate with a second WTRU based on the C2 authorization and the C2 authorization information, wherein the C2 authorization information comprises an identity of the second WTRU; and
sending a third message to the second WTRU using PC5 if the first WTRU is authorized to communicate with the second WTRU, wherein the third message indicates a request to perform a link establishment procedure.

33. The method of claim 32, wherein the C2 authorization information comprises a security credential, and wherein the third message is encrypted based on the security credential.

34. The method of claim 32, wherein the C2 authorization information comprises a security credential, and wherein the security credential is an authorization token.

35. The method of claim 32, wherein the C2 authorization information comprises a security credential wherein the method further comprises:
determining, based on the security credential, a security key or a security token, and wherein the third message is based on the determined security key or determined security token.

36. The method of claim 32, wherein the C2 authorization information further comprises an unmanned aerial vehicle controller (UAV-C) application identifier.
